(19) United States
(12) Patent Application Publication
(10) Pub. No.: US 2006/0016564 A1
(43) Pub. Date: Jan. 26, 2006

(54) Gluing device

(76) Inventors: Wolfgang Holzer, Wallhalben (DE); Thomas Freichel, Lebach (DE); Dan Nielsen, Cambridge (CA)

Correspondence Address: WILLIAM COLLARD;COLLARD & ROE, P.C., 1077 NORTHERN BOULEVARD, ROSLYN, NY, 11576, US

(21) Appl. No.: 11/131,803

(22) Filed: May 18, 2005

(30) Foreign Application Priority Data
May 18, 2004 (DE) 202004008216.0

(51) Int. Cl. B65C 11/04; B05B 13/06

(52) U.S. Cl. 156/578; 118/317

(57) ABSTRACT

A gluing device for gluing wood chips comprises a drum and a plurality of locally fixed discharge devices for glue disposed inside the drum at least substantially along a line running parallel to a longitudinal axis of the drum. There are support surfaces for the wood chips formed on an inner surface of the drum by noses directed at least substantially toward the longitudinal axis, the support surfaces differing in length or orientation relative to the longitudinal axis of the drum.

### BACKGROUND OF THE INVENTION

1. Field of the Invention

The invention relates to a gluing device for gluing wood chips.

2. The Prior Art

Such gluing devices are known to the applicant. These gluing devices are used for gluing wood chips before further processing thereof. As an example, further processing can comprise pressing the wood chips to obtain a board. Such a gluing device is provided with a drum, inside which wood chips are disposed. By rotation of the drum, these wood chips are moved in the drum. This drum is provided with noses on the inside of the surface. The noses are directed substantially toward the central axis of the drum and are identical in shape and size.

Inside the drum there are disposed, at least substantially along a line running parallel to the longitudinal axis of the drum, a plurality of locally fixed discharge devices for glue. These discharge devices spray the glue out in at least substantially parallel manner. By the rotation of the drum, the wood chips are now supposed to be swirled up, so that they become glued by the glue sprayed out by the discharge devices. Support surfaces on the inner outside circumference of the drum are formed by the noses. Supported on these support surfaces, the wood chips are transported upward during rotation of the drum. Because of gravity, the wood chips fall from the support surfaces when a certain height is reached. The wood chips thus fall past the discharge devices and in the process become glued.

The discharge devices can be designed as nozzles or also as atomizers or rotary nebulizers. In these rotary nebulizers, the glue drops onto at least one rotating element and is nebulized by the centrifugal forces.

### SUMMARY OF THE INVENTION

It is an object of the present invention to improve the gluing of the wood chips.

This object is achieved according to the present invention by the fact that the support surfaces differ in length and/or orientation relative to the central axis.

The support surfaces can be advantageously dimensioned and arranged in such a way that, during rotation of the drum, some of the chips are supported longer on the corresponding support surface than another part of the chips that is supported on another support surface. Due to the fact that some of the chips are supported longer on the corresponding support surface than other chips are supported on another support surface, the chips fall downward on both sides of the line on which the discharge devices for the glue are disposed.

Therefore, the glue can be advantageously better absorbed by the wood chips, because the gluing process is organized more efficiently. This proves to be advantageous, because the glue represents a non-negligible cost aspect for manufacture of the boards. By more efficient use of the glue, therefore, costs can be advantageously saved during production, by the fact that the glue is used more efficiently. A further advantage of more efficient use of the glue consists in the fact that the drum is less severely contaminated by unused glue. Cleaning of the drum is comparatively expensive. Thus, production becomes simpler and more efficient when the frequency of the necessary cleaning operations is reduced.

In one embodiment noses disposed next to one another in pairs differ in their length and/or orientation.

Therefore, wood chips falling from neighboring support surfaces fall downward on different sides of the line along which the discharge devices for the glue are disposed. This produces the most uniform stream possible of downwardly falling wood chips on both sides of the line, so that the glue discharged by the discharge devices is used efficiently.

Preferably, the support surfaces are designed with different lengths. If the dwell time of the wood chips on the support surface is to be prolonged solely by the orientation of the support surface, the support surface forms an acute angle with the tangent to the circular drum at the point of attachment of the nose. Since the glue cannot be completely used, “clogging” can occur between the support surface and the drum, because the volume in the acute angle can become filled with glue. It is at this very point that cleaning of the drum would then also be correspondingly more difficult.

In the present invention, it is possible on the whole to provide more than one beam with discharge devices. In particular, therefore, two beams containing discharge devices can also be provided inside the drum. By the shape of the beams with the roof—especially with the shedding elements and the diverting elements—it can be advantageously achieved that excessive gluing of individual wood chips is avoided. Likewise, insufficient gluing can also be avoided.

### BRIEF DESCRIPTION OF THE DRAWING

Other objects and features of the present invention will become apparent from the following detailed description considered in connection with the accompanying drawing. It is to be understood, however, that the drawing is designed as an illustration only and not as a definition of the limits of the invention.

FIG. 1 shows a gluing drum in a section perpendicular to the longitudinal axis.

### DETAILED DESCRIPTION OF THE PREFERRED EMBODIMENT

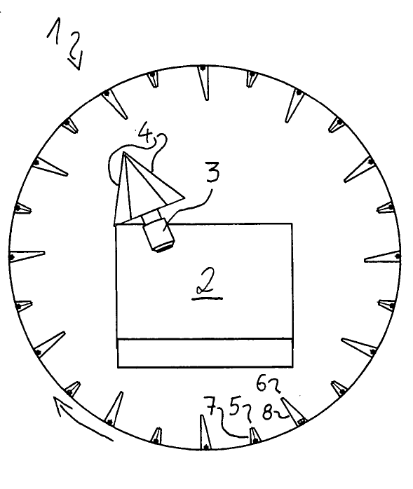

FIG. 1 shows a gluing drum 1 having a discharge opening 2 for the glued wood chips, which opening is disposed at the rear end of drum 1. In order to achieve feed of the wood chips in the longitudinal direction of drum 1, drum 1 can be mounted with the longitudinal axis inclined in the direction of discharge opening 2.

In the sectional diagram of the figure there can be seen a discharge device 3. The other discharge devices, which are disposed in a row with discharge device 3, are concealed in the diagram of the figure. It can be further seen that discharge device 3 has a roof 4, which has a slope toward both sides. Wood chips that would fall from above onto discharge device 3 during rotation of the drum then fall onto roof 4 and slide down laterally because of its slope, so that these wood chips also fall laterally past discharge device 3.

Noses 5 and 6 can be seen on the inside of the cylindrical surface of drum 1. In the illustrated practical example there are indicated two noses 5 and 6. It can be seen that such noses are disposed circumferentially and repeatedly.

In this connection, noses 5 are shorter than noses 6. Furthermore, support surface 7 of the shorter nose 5 has a steeper inclination than support surface 8 of longer nose 6. The dwell time of the wood chips on the respective support surfaces 7, 8 is different during rotation of drum 1. If the wood chips are being transported upward on the respective support surfaces 7, 8 during rotation, the wood chips begin to slide off the respective support surfaces 7, 8 when their inclination is directed downward toward the free end of support surfaces 7, 8 due to rotation of the drum.

Depending on the inclination of support surfaces 7, 8, the wood chips supported thereon begin when to slide downward from these support surfaces 7, 8 at different angles of rotation of drum 1.

The instant (or angle of rotation of drum 1) at which the wood chips have then reached the free end of the respective support surface 7 or 8 and fall downward freely can therefore be adjusted by the length of support surfaces 7 and 8 (or in other words the length of noses 5 and 6) as well as the inclination of the respective support surfaces 7 and 8.

In this connection, it is possible to configure noses 5 and 6 differently both as regards length and as regards the inclination of their support surfaces 7 and 8. This can be seen in the practical example of the figure. It is also possible, however, to configure noses 5 and 6 differently as regards only one of these parameters. This means that noses 5 and 6 can be equally long with different inclinations of support surfaces 7 and 8 or can be differently long with equal inclinations of support surfaces 7 and 8.

Advantageously, noses 5 and 6 are configured differently in pairs disposed next to one another, so that, from noses 5 and 6 following one another, the wood chips fall down respectively on different sides of the line formed by discharge devices 3.

Accordingly, while only a few embodiments of the present invention have been shown and described, it is obvious that many changes and modifications may be made thereunto without departing from the spirit and scope of the invention.

What is claimed is:

1. A gluing device for gluing wood chips, comprising:
a drum;
a plurality of locally fixed discharge devices for glue disposed inside the drum at least substantially along a line running parallel to a longitudinal axis of the drum;
support surfaces for the wood chips formed on an inner surface of the drum by noses directed at least substantially toward the longitudinal axis, the support surfaces differing in length or orientation relative to the longitudinal axis of the drum.

2. A gluing device according to claim 1, wherein the support surfaces are disposed next to one another in pairs, said support surfaces differing in length or orientation relative to the longitudinal axis of the drum.
